(19) United States
(12) Patent Application Publication
(10) Pub. No.: US 2016/0053133 A1
(43) Pub. Date: Feb. 25, 2016

(54) MOLECULARLY SELF-ASSEMBLING NANOCOMPOSITE BARRIER COATING FOR GAS BARRIER APPLICATIONS AND FLAME RETARDANCY

(71) Applicants: Gary W. Beall, San Marcos, TX (US); Ray G. Cook, New Braunfels, TX (US)

(72) Inventors: Gary W. Beall, San Marcos, TX (US); Ray G. Cook, New Braunfels, TX (US)

(21) Appl. No.: 14/811,002

(22) Filed: Jul. 28, 2015

Related U.S. Application Data
(60) Provisional application No. 61/999,455, filed on Jul. 28, 2014.

(51) Int. Cl. C09D 171/02; C09D 139/06; A23L 1/00; C09D 129/04

(52) U.S. Cl. CPC C09D 171/02; C09D 129/04; C09D 139/06; A23L 1/0047; C08K 3/346

(57) ABSTRACT

Disclosed is a transparent self-assembling polymer clay nanocomposite coating that is useful in food, drink and electronic packaging as a gas barrier and on textiles and clothing as a flame retardant coating. The coating consists of two main components that include a water dispersible polymer and a sheet like nanoparticle. The polymers are polyvinylpyrrolidone or polyacrylic acid and or co-polymers with pyrrolidone or acrylic acid and the nanoparticles include smectite clays and double metal hydroxides. The coatings can be applied to any substrate. The coatings are applied sequentially with polymer being applied first followed by the nanoparticles. This sequence results in the self-assembly of a highly ordered nanocomposite film that exhibits high barrier properties and flame retardancy. The desired level of gas barrier or flame retardancy desired can be adjusted by the number of bilayers applied. The coating can be applied by ink jet printing, rotogravure printing, doctor knife, dip coating, paint sprayer, or any other method that gives control of layer thickness. The gas barrier performance of 5 bilayers of coatings of this invention exceed that of aluminized mylar yet are transparent.

### CROSS-REFERENCE TO RELATED APPLICATIONS

This application claims priority to Provisional Patent Application No. 61/999,455, filed Jul. 28, 2014, which is hereby incorporated by reference in its entirety.

### FIELD OF THE INVENTION

The technical fields of this invention relates to gas barriers for at least food packaging, beverage containers, and electronic packaging for organic light emitting diodes (OLED) and flame retardant coatings for upholstery and clothing.

### BACKGROUND

In the area of food and beverage packaging the use of thermoplastic polymers has virtually eliminated the use of other forms of packaging when the ingress or egress of oxygen, water vapor or carbon dioxide is of importance. Many of the polymers commonly employed today however don't give shelf lives that retail food markets would like. A good example is carbonated drinks where the shelf life issue is loss of carbonation. Carbonated drinks are normally packaged in polyethylene terephthalate (PET) bottles. These bottles for large volumes of 2 and 3 liter give shelf lives of slightly over 100 days. They however yield substantially shorter shelf lives for small volume containers. This allows glass bottles and aluminum cans to continue to compete with plastic in this segment. There are several other examples where ingress of oxygen present a big problem for simple single layer packages. The first example is beer which largely must be packaged in glass or aluminum since it is very sensitive to ingress of oxygen. The second example is catsup which currently requires either glass or a 5 to 7 layer bottle to protect the contents from oxygen. In the area of flexible food packaging one solution to barrier films for highly sensitive foods is aluminized coatings on various polymer substrates. These type of packages are commonly utilized for such foods as potato chips and pastries. They yield good barrier properties but they are expensive, produce substantial waste and are opaque. There is clearly a need for packaging that can produce excellent gas barrier and be transparent.

There have been many approaches tried to produce high barrier packages that maintain transparency. The first approach has been to form nanocomposites between the polymer normally utilized in the packaging application and an organically modified smectic type nanoparticle. Examples of such efforts include U.S. Pat. No. 6,486,253 where organically modified montmorillonite was exfoliated in PET using melt compounding, WO 93/04117 and WO93/04118 discloses a wide range of polymers melt blended with dispersed platelets. There are also example such as U.S. Pat. No. 4,739,007 where the clay nanoparticles were first dispersed in monomer followed by polymerization to form nylon 6 and U.S. Pat. No. 4,889,885 the same approach was taken with montmorrillonite and polymerization of various vinyl polymers. U.S. Pat. No. 7,619.024 discloses the melt blending of MXD6 polyamide and a polyphenoxy resin with an organically modified montmorillonite to produce a barrier film. This film however is sensitive to heat treatment and will crystalize and become opaque. It is also sensitive to humidity. All of these approaches have had limited utility for several reasons. The first problem is that nanocomposites are limited to the range of 2 to 4% by weight because above this level the nanocomposites start to lose clarity and the physical properties start to degrade. At the upper limit of 4% it is difficult to fully exfoliate the plates which is critical for good barrier properties. With these limitations packages made with these nanocomposites only yield a factor of 2 to 3 improvement in barrier.

Another approach to solving this problem has been to develop coatings to treat the substrate polymer package with as a post treatment. These approaches include cases where compositions are disclosed where plate like particles are dispersed in the coating. For example WO 95/26997 discloses the dispersion of mica, glass flakes or aluminum flake into polyepoxide-polyamine barrier coating to improve the barrier. These however give limited improvement and sacrifice clarity. U.S. Pat. No. 4,528,235 and 1,018,528 disclose the use of mica, platelet silica, flake glass, and flaked glass at high loadings in polycaprolactam and high density polyethylene to improve barrier. These again sacrifice clarity for nominal gains in barrier. U.S. Pat. No. 5,840,825 describes a gas barrier coating consisting of a thermoset formulation with platy micron sized particles dispersed into it. The platy material include mica, clay, talc, iron oxide, silica flake, graphite, flaked glass, or flaked thalocyanine. The thermoset polymer is a polyamine and a polyepoxide. These coatings suffer from the same problems as stated above and don't qualify as nanocomposites and don't demonstrate self-assembly. U.S. Pat. Nos. 8,007,895 and 8,206,814 discloses the dispersion of clay into water with a small amount of water soluble resin with subsequent coating onto a substrate followed by drying. The reported coating has a minimum of 70% clay and yields good barrier and clarity. This disclosure however doesn't anticipate self-assembly of a highly ordered high barrier coating not requiring pre mixing of the components.

In the manufacturing of display screens utilizing OLED technology there is a very stringent need for coatings to protect the OLED from oxygen and moisture. The current technology involves the application of as much seven layers of thin glass over the OLED's. This is very expensive and difficult to implement on larger areas. Attempts have been made to produce simpler coatings that exhibit the necessary barrier properties and yet maintain the transparency needed in these displays. An example is U.S. Pat. No. 7,951,726 where it is disclosed that OLEDS can be coated with a photocured resin that is UV cured followed by a coating of two inorganic materials that can include metal oxides, non-metal oxides, nitrides, and salts. The inorganic coating is applied by sputter coating, physical vapor deposition, chemical vapor deposition, or atomic vapor deposition. This is still a very expensive process that is difficult to implement at large scale. This approach doesn't anticipate the self-assembly of a highly ordered barrier films.

Imparting flame retardancy to substrates such as upholstery, bedding and sleep ware especially for young children is important. Until now this has been accomplished by adding various types of chemicals that either quench free radical formation or form char layers or both. These chemicals however are not good to expose young children to and in many cases produce toxic by products when burned. A completely different approach to flame retardancy , which addresses the toxicity issue, is the so called layer by layer technique. These coatings also yield high barrier films. Recent work by Grunlan etal has demonstrated that coatings made by the LBL technique can yield high barrier materials and can impart flame retardancy to substrates without the use of harmful chemicals. The layer by layer process involves dipping the substrate in solutions of a polyelectrolyte polymer and a smectic clay. Between each dip the substrates are rinsed to remove excess reagent and dried. This process is very cumbersome and is difficult to implement on a commercial scale it also produces a lot of waste from the rinse. None of the layer by layer work anticipates the self-assembly of highly ordered barrier composites.

It has been known for many years and practiced commercially to treat clays with quaternary ammonium compounds to change them from being hydrophilic to hydrophobic. The number of commercially available quaternary ammonium compounds severely limits the number of polymers that are compatible with those chemistries. More recently in order to form nanocomposites with a wider range of polymers U.S. Pat. No. 5,522,469 discloses a new way to surface modify clays. This method involves the interaction between exchangeable cation on the surface of the clay with a polar group on the organic molecule or polymer via ion-dipole bonding. This patent discloses a whole host of polymers and oligomers that can interact with the smectite clay. It however doesn't anticipate the self-assembly of the highly ordered nanocomposite of this invention.

It has been unexpectedly discovered that certain polymers in combination with selected nanoparticles will form a self-assembling highly ordered nanocomposite when applied in the proper way that yields extremely high gas barrier performance and flame retardancy and yet is transparent and is the invention of this patent.

### BRIEF SUMMARY OF THE INVENTION

The disclosure provides a transparent self-assembling highly ordered polymer nanocomposite coating on a substrate. In embodiments, coated substrate may be extremely impermeable to gases. The coated substrate may comprise a water dispersible polymer including side groups on the backbone that may be polar or ionic and that may be bulky in embodiments. The coated substrate may further comprise a platy nanoparticle with a large aspect ratio that may have small ions or molecules on their surfaces that can readily be exchanged through ion exchange or ion-dipole bonding.

The disclosure may further provide a transparent self-assembling highly ordered polymer nanocomposite coating on a substrate that may impart flame retardancy. The coated substrate may comprise a water dispersible polymer that includes side groups on the backbone that may be polar or ionic and that may be bulky in embodiments. The coated nanoparticle may further comprise a platy nanoparticle with a large aspect ratio that may have small ions or molecules on their surfaces that may readily be exchanged through ion exchange or ion-dipole bonding.

The disclosure may further provide a transparent self-assembling highly ordered polymer nanocomposite edible coating that may be directly applied to food. In embodiments, the coating may be extremely impermeable to gases and may comprise a water dispersible polymer that includes side groups on the backbone that may be polar or ionic and that may be bulky. The coating may further comprise a platy nanoparticle with a large aspect ratio that may have small ions or molecules on their surfaces that can readily be exchanged through ion exchange or ion-dipole bonding.

The disclosure may further provide a transparent self-assembling highly ordered polymer nanocomposite edible coating that may be applied to protect OLED's from degradation that may be extremely impermeable to gases comprised of a water dispersible polymer that includes side groups on the backbone that may be polar or ionic and that may be bulky and a platy nanoparticle with a large aspect ratio that may have small ions or molecules on their surfaces that may readily be exchanged through ion exchange or ion-dipole bonding.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features, and advantages here provided will become apparent to one with skill in the art upon examination of the following FIGURES and detailed description. It is intended that all such additional systems, methods, features, and advantages that are included within this description, be within the scope of the appended claims and/or those claims filed later.

### BRIEF DESCRIPTIONS OF THE DRAWINGS

The novel features believed characteristic of the presently disclosed subject matter are set forth in the claims appended hereto or will be set forth in any claims that are filed herewith or later. The presently disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 is the x-ray powder pattern obtained on a 6 bilayer printed film using PVOH and MMT.

FIG. 2 is the x-ray powder pattern obtained on a 6 bilayer printed film using PEG and MMT.

FIG. 3 is the self-assembled highly ordered of a 3 bilayer film using PVP and MMT.

FIG. 4 is the Gas barrier properties of films made with various combinations of polymers and MMT.

### DETAILED DESCRIPTION OF THE SPECIFIC EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In order to form the highly ordered self-assembled nanocomposite of this invention requires specific chemical components and mode of addition. The process of self-assembly appears to be driven by entropic forces. The entropic driver is due to the fact that every polymer molecule that intercalates into the clay displaces thousands of moles of small molecules or ions. Therefore the entropy increase of the small molecules or ions is much larger than the entropy decrease of the polymer. In the broadest sense any nanoparticle that contains small molecules associated with the clay surface that can be displaced by bonding with a polymer will undergo the intercalation reaction of this invention. This single criteria is not sufficient to result in the self-assembly of the highly ordered nanocomposite. In addition to this first criteria the polymer must also be configured in a way that makes it difficult for the polymer to coil tightly. This normally will take the form of a side group that is somewhat bulky yet polar enough to undergo bonding with the clay surface. In addition the bulky side group when bonding to the clay surface orients the adjacent groups in a way that makes it difficult for the adjacent groups to bond with an adjacent clay platelet. If the polymer is too flexible the adjacent polar groups will bond between plates and essential halt intercalation. An additional aspect of the invention is that the addition of polymer and nanoparticle should be added to the substrate sequentially. The best results are obtained when each layer is allowed to dry prior to applying the next layer. This process allows the surface tension of the fluid to aid in orienting the platy nanoparticles parallel to the surface of the substrate.

The nanoparticles useful in this invention have several specific characteristics that are critical. The first is that they be plate like having an aspect ratio of at least 30 and more preferably greater than 100. The plates should be able to undergo intercalation and exfoliation with the primary particle thickness (smallest dimension) being 1 nm. These particles must also be dispersible in water or water solvent mixtures. The preferred concentration of the dispersed particles should be less than 2% by weight. They should also have easily exchangeable small molecules or ions associated with the surface of the particle. One class of nanoparticles that fit these criteria includes magnesio and alumino silicates. Specifically smectite clays and micro fine vermiculites. Among the smectite clays natural and synthetic montmorillonite and hectorite are preferred. In the case of the smectites there are substantial amounts of exchangeable cations on the surface that can be ion exchanged and typically the exchangeable cation has molecules of water hydrating the cation that can also be displaced. Another class of platy nanoparticles that satisfy the criteria are double metal hydroxides. The preferred double metal hydroxide is hydrotalcite. Hydrotalcite is a cationic clay which has exchangeable anions on the surface. The preferred anions are chloride or nitrate. The least preferred anions are carbonate, sulfate, and phosphate.

The polymers that are useful in this invention must exhibit several characteristics. First they must have polar or ionic groups that can interact with the nanoparticle forming a intercalated complex and displacing small molecule or ions previously bonded to the clay. Typical polar groups include carbonyls, hydroxides, ethers, and halogens. Typical ionic groups include carboxylic acids and protonated amines. Secondly the polymer must have polar side groups that are bulky. This is important for two reasons. The first is that the bulky side group doesn't allow the polymer to coil as tightly and therefore the loss in entropy will be lower when it flattens out on the clay surface. The second function of the bulky group is that once the polar group bonds to the clay it orients the adjacent groups in such geometry that steric hindrance prevents it from bonding to any adjacent plate. Lastly the polymers must be dispersible in aqueous solution or mixtures of water and co-solvents. The preferred polymers of this invention are vinyl polymers. They can be homo or block co-polymers. For smectite nanoparticles the preferred polymers are polyvinylpyrrolidone and block co-polymers of polyvinylpyrrolidone. The co-monomer to produce the block co-polymers with pyrrolidone can be any common vinyl monomer that will readily polymerize with vinylpyrrolidone. In addition another preferred polymer for smectites is branched polyethylenimine or any vinyl polymer with an amine side group such polyaminostyrene or co-polymers of polyaminostyrene. The preferred polymers for use with hydrotalcite are anionic polyelectrolytes such as polyacrylic acid or co-polymers of polyacrylic acid. Polymers that don't work well are polyethylene oxide or polyvinyl alcohol.

The method of forming the nanocomposites is also important. Dilute solutions of the polymer and nanoparticles are made separately. The solutions should be less than 2% by weight and more preferably less than 1% or more preferably between 0.01 and 0.25%. The solutions can be applied to the substrate in a number of ways but should always be applied as alternating layers with drying in between each layer. One layer of polymer and one layer of nanoparticle application is call a bilayer. This is somewhat a misnomer since the layer of polymer and the layer of nanoparticles spomtaneously self-assemble into a highly ordered nanocomposite a bilayer nolonger exist but it is a convenient way to discuss the coating and compare it to systems that do not self-assemble. The layers can be applied using a doctor knife, a draw down bar, rotogravure printing, ink jet printing, and paint sprayer. The preferred method of application is ink jet printing.

The coatings once produced can later be cross-linked to produce films that are hydrlitically stable and improve their water vapor transmission rate. The crosslinking can be done with UV or other higher energy radiation as is commonly done in the art.

### Example 1

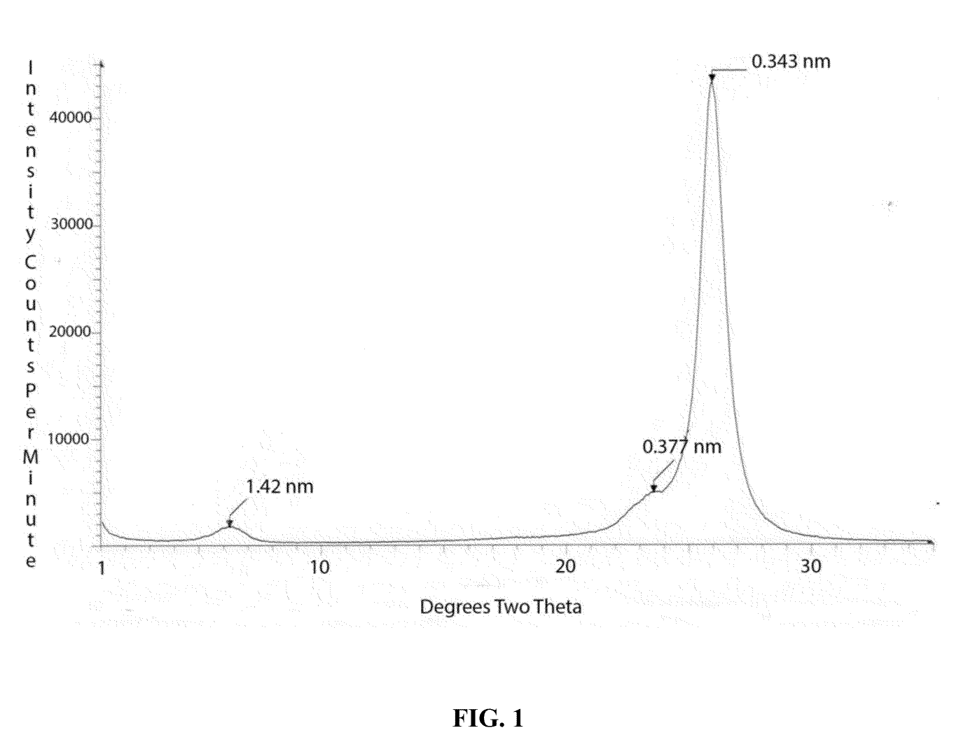

This is an example that can act as a comparative case where self-assembly does not occur. In this example a solution of polyvinylalcohol (PVOH) was made at 0.2% by weight. Likewise dilute solutions of sodium montmorillonite were made at 0.2% by weight. These solutions were printed sequentially with an ink jet printer on to a mylar substrate in 2.5 cm squares. A total of 6 squares were printed with the first having one bilayer and the second having two bilayers continuing up to the sixth square that had six bilayers. The squares were then x-rayed in a powder diffractometer. FIG. 1 contains the x-ray powder pattern of the sample containing 6 bilayers. The large diffraction peak at about 25 degrees two theta is from the PET substrate as well as the smaller peak at about 23.6 degrees. The only peak arising from the coating is a broad weak peak at 6.28 degrees. This peak is characteriastic of hydrated montmorillonite. There appears to be little if any intercalation of the PVOH. The broadness of the peak also indicates that it is not highly ordered.

### Example 2

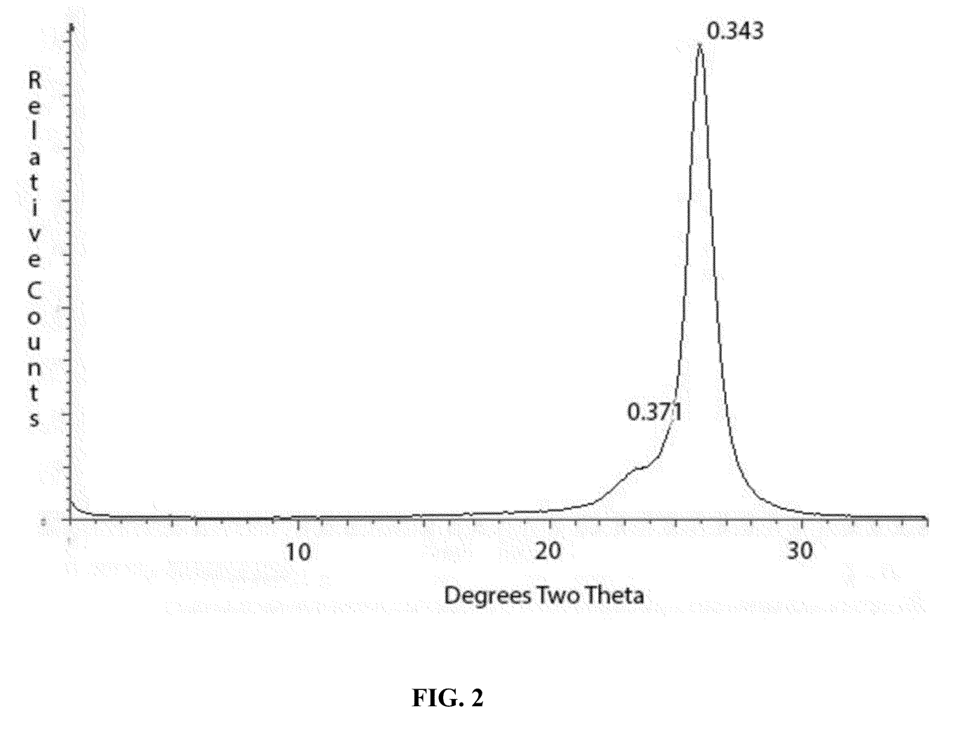

This is an example that can act as a second comparative case where self-assembly does not occur. In this example a solution of polyethylene oxide (PEO) was made at 0.2% by weight. Likewise dilute solutions of sodium montmorillonite were made at 0.2% by weight. These solutions were printed sequentially with an ink jet printer on to a mylar substrate in 2.5 cm squares. A total of 6 squares were printed with the first having one bilayer and the second having two bilayers continuing up to the sixth square that had six bilayers. The squares were then x-rayed in a powder diffractometer. FIG. 2 contains the x-ray powder pattern of the sample containing 6 bilayers. The large diffraction peak at about 25 degrees two theta is from the PET substrate as well as the smaller peak at about 23.6 degrees. The only peak arising from the coating is a broad weak peak at around 4 degrees that is barely discernable. This peak is characteriastic of montmorillonite intercalated with one layer of PEO. There appears to be poor if any intercalation of the PEO. The broadness and weakness of the peak also indicates that it is not ordered very well.

### Example 3

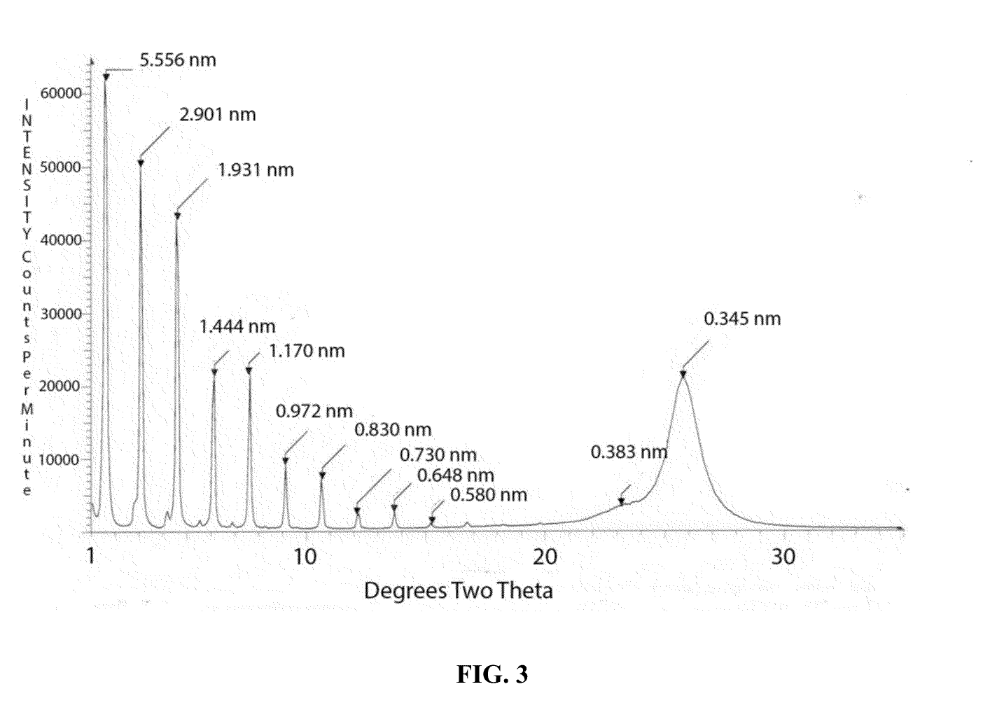

In this example a solution of polyvinylpyrrolidone (PVP) was made at 0.2% by weight. Likewise dilute solutions of sodium montmorillonite were made at 0.2% by weight. These solutions were printed sequentially with an ink jet printer on to a mylar substrate in 2.5 cm squares. A total of 6 squares were printed with the first having one bilayer and the second having two bilayers continuing up to the sixth square that had six bilayers. The squares were then x-rayed in a powder diffractometer. FIG. 3 contains the x-ray powder pattern of the sample containing 3 bilayers. It can be seen that the peaks for the PET substrate are still present however they are much demished compared to the previous example. In addition there are a series of very sharp intense peaks starting at 1.59 degrees two theta arising from an intercalated complex formed between the PVP and the clay. The first peak represents a d-spacing of approximately 55 angstroms and the other peaks at higher angle or orders of this first peak. At least 12 orders can be seen in the pattern. This is unprecedented in polymer/clay nanocomposites. In over 25 years of nanocomposite research I have never seen this level of ordering. The high degree of order is also reflected in the intensity and sharpness of the peaks. In comparison to example 1 the full with at half maximum was 1.5 degrees while this example the same parameter is 0.25 degrees. The peak in example 2 is so weak and broad that no FWHM could be obtained. This highly ordered and highly intercalates structure that forms spontaneously is totally unexpected.

### Example 4

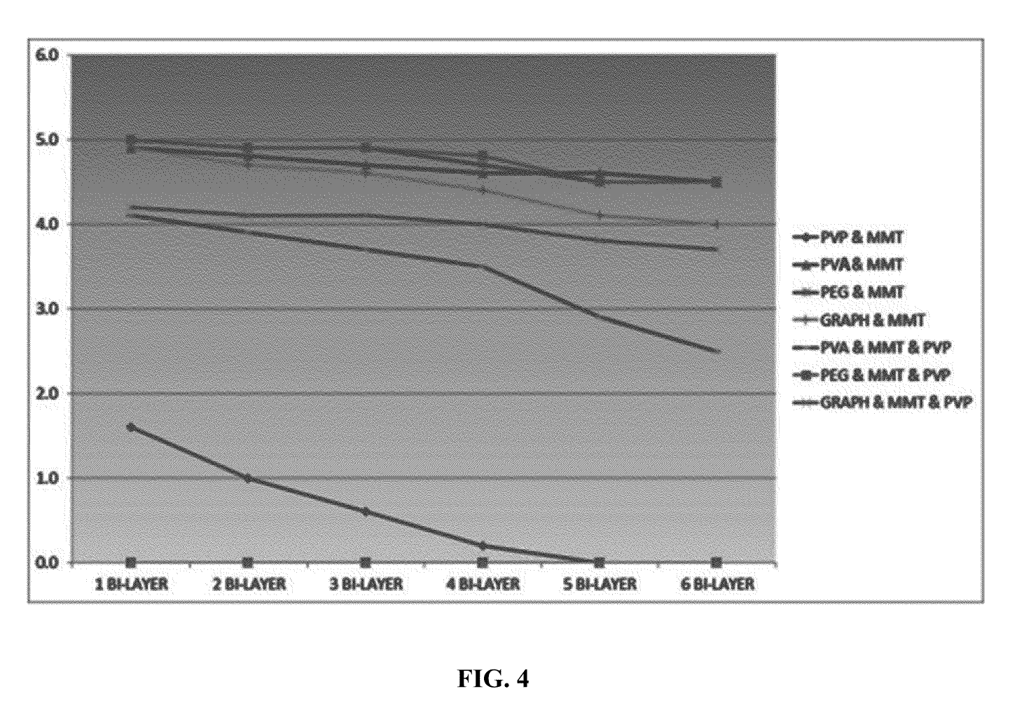

The utility of this highly ordered self-assembling nanocomposite can be illustrated by measuring the oxygen permeability of the film produced in examples 1, 2 and 3. All of the samples were placed in a Mocon oxytran instrument and the oxygen permeation rate determined. FIG. 4 contains the results of those tests. The top four curves that contain PVA, PEG, Graphenol, and some where one layer of PVP is added first show very little if any improvement in oxygen permeability. The only curve that shows some slight improvement is the PVA with MMT pretreated with PVP. In contrast even on bilayer of PVP and MMT by a factor of 3. At 5 bilayers the gas permeability reaches the detection limit of the Mocon unit. At 4 bilayers the performance is equivalent to aluminized mylar.

### Example 5

Strips of cotton linen approximately 2 inches wide and 12 inches long were cut from a T-shirt. One strip was sequentially sprayed with alternating solutions of 0.2% PVP and MMT until 10 bilayers had been applied. Untreated and treated linen strips were then suspended from a coat hanger with metal clips. Each strip was then exposed to a propane torch for a few seconds. The untreated linen burst into flames and was completely burned up in a few seconds. The linen sample that was treated started to combust but when the torch was removed self-extinguished stopping further combustion. Only about 20% of the linen was charred.

In embodiments, the nanocomposite coating may comprise nanoparticles that may be at least one of montmorillonite, hectorite, laponite, and hydrotalcite.

In embodiments, polymers may be polyvinyl pyrrolidone. In embodiments, the polymers may be co-polymers of polyvinylpyrrolidone and/or polycationic polymers such as polyamino styrene for the smectite nanoparticles and polyacrylic acid and co-polymers of acrylic acid, sulfated or phosphate polymers for double metal hydroxides.

In embodiments, the solutions utilized to apply the coating may be less than 1% by weight of a polymer or nanoparticle.

In embodiments, the solution concentrations may be 0.1% and 0.5% by weight.

In embodiments, the coating may be treated with radiation to crosslink the coating to improve hydrolytic stability.

In embodiments, the radiation utilized in the treatment of the coating may be UV light.

In embodiments, the radiation utilized in the treatment of the coating may be gamma rays.

In embodiments, the method of applying the nanocomposite coating may comprise at least one of paint sprayers, doctor knife, drawdown bars, rotogravure printing, and ink jet printing.

Embodiments may comprise a transparent self-assembling highly ordered polymer nanocomposite edible coating that may be applied to protect OLED's from degradation that may be extremely impermeable to gases that may be comprised of a water dispersible polymer may have side groups on the backbone that may be polar or ionic and that may be bulky and a platy nanoparticle with a large aspect ratio that may have small ions or molecules on their surfaces that may readily be exchanged through ion exchange or ion-dipole bonding.

In embodiments, the coating may be produced by sequentially applying the polymer followed by the nanoparticle iteratively.

In embodiments, the nanoparticles of interest may be at least one of smectic clays or double metal hydroxides.

In embodiments, the nanoparticles may be at least one of montmorillonite, hectorite, laponite, and hydrotalcite.

In embodiments, the polymers may be polyvinyl pyrrolidone. In embodiments, the polymers may be co-polymers of polyvinylpyrrolidone and/or polycationic polymers such as polyamino styrene for the smectite nanoparticles and polyacrylic acid and co-polymers of acrylic acid, sulfated or phosphate polymers for double metal hydroxides.

In embodiments, the solutions utilized to apply the coating may be less than 1% by weight of the polymer or nanoparticle.

In embodiments, the solution concentrations may be 0.1% and 0.5% by weight.

In embodiments, the coating may be treated with radiation to crosslink the coating to improve hydrolytic stability.

In embodiments, the radiation utilized to treat the coating may be UV light.

In embodiments, the radiation utilized to treat the coating may be gamma rays.

The foregoing description of the preferred embodiments is provided to enable a person skilled in the art to make or use the claimed subject matter. Various modifications to these embodiments, including changing point values and/or adding or deleting point opportunities, will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

Further, although exemplary devices and figures to implement the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same.

1. A transparent self-assembling highly ordered polymer nanocomposite coating on a substrate that is extremely impermeable to gases comprised of a water dispersible polymer that has side groups off of the backbone that are polar or ionic and that are bulky and a platy nanoparticle with a large aspect ratio that has small ions or molecules on their surfaces that can readily be exchanged through ion exchange or via ion dipole bonding.

2. A nanocomposite coating as described in claim 1 where the coating is produced by sequentially applying the polymer followed by the nanoparticle iteratively.

3. A nanocomposite coating as described in claim 1 where the nanoparticles of interest are smectic clays or double metal hydroxides.

4. A nanocomposite coating as described in claim 1 where the nanoparticles are preferably montmorillonite, hectorite, laponite, or hydrotalcite.

5. A nanocomposite coating as described in claim 1 where the polymers are polyvinyl pyrrolidone or co-polymers of polyvinylpyrrolidone and polycationic polymers such as polyamino styrene for the smectite nanoparticles and polyacrylic acid and co-polymers of acrylic acid, sulfated or phosphate polymers for double metal hydroxides.

6. A nanocomposite coating as described in claim 1 where the solutions utilized to apply the coating are less than 1% by weight of the polymer or nanoparticle.

7. A nanocomposite coating as described in claim 1 where the solution concentrations are 0.1% and 0.5% by weight.

8. A nanocomposite coating as described in claim 1 where the substrate can be any polymer, metal or glass.

9. A transparent self-assembling highly ordered polymer nanocomposite coating on a substrate that imparts flame retardancy comprised of a water dispersible polymer that has side groups off of the backbone that are polar or ionic and that are bulky and a platy nanoparticle with a large aspect ratio that has small ions or molecules on their surfaces that can readily be exchanged through ion exchange or via ion dipole bonding.

10. A nanocomposite coating as described in claim 9 where the coating is produced by sequentially applying the polymer followed by the nanoparticle iteratively.

11. A nanocomposite coating as described in claim 9 where the nanoparticles of interest are smectic clays or double metal hydroxides.

12. A nanocomposite coating as described in claim 9 where the nanoparticles are preferably montmorillonite, hectorite, laponite, or hydrotalcite.

13. A nanocomposite coating as described in claim 9 where the polymers are polyvinyl pyrrolidone or co-polymers of polyvinylpyrrolidone and polycationic polymers such as polyamino styrene for the smectite nanoparticles and polyacrylic acid and co-polymers of acrylic acid, sulfated or phosphate polymers for double metal hydroxides.

14. A nanocomposite coating as described in claim 9 where the solutions utilized to apply the coating are less than 1% by weight of the polymer or nanoparticle.

15. A nanocomposite coating as described in claim 9 where the solution concentrations are 0.1% and 0.5% by weight.

16. A nanocomposite coating as described in claim 9 where the substrate can be any polymer or textile either woven or nonwoven.

17. A transparent self-assembling highly ordered polymer nanocomposite edible coating directly onto food that is extremely impermeable to gases comprised of a water dispersible polymer that has side groups off of the backbone that are polar or ionic and that are bulky and a platy nanoparticle with a large aspect ratio that has small ions or molecules on their surfaces that can readily be exchanged through ion exchange or via ion dipole bonding.

18. A nanocomposite coating as described in claim 17 where the food is bread, pastries, fruit, or meats.

19. A nanocomposite coating as described in claim 17 where the coating is produced by sequentially applying the polymer followed by the nanoparticle iteratively.

20. A nanocomposite coating as described in claim 17 where the nanoparticles of interest are smectic clays or double metal hydroxides.
